(19) United States
(12) Patent Application Publication
(10) Pub. No.: US 2014/0365371 A1
(43) Pub. Date: Dec. 11, 2014

(54) ELECTRONIC PAYMENT SYSTEM

(71) Applicant: Safety Pay, Inc., Miami Beach, FL (US)

(72) Inventor: Ralf Ohlhausen, Frankfurt am Main (DE)

(73) Assignee: Safety Pay, Inc., Miami Beach, FL (US)

(21) Appl. No.: 14/363,415

(22) PCT Filed: Dec. 7, 2012
(86) PCT No.: PCT/US12/68539

§ 371 Date: Jun. 6, 2014

Related U.S. Application Data
(60) Provisional application No. 61/568,911, filed on Dec. 9, 2011.

(51) Int. Cl. G06Q 20/42

(52) U.S. Cl. CPC G06Q 20/42
USPC 705/44

(57) ABSTRACT

A specially configured computer for transferring money to a merchant, company, or other individual. The computer may comprise a barcode receiver configured to receive a copy of a barcode generated by the merchant, a barcode decoder configured to decode the barcode information with an application, a data input configured to receive customer information in an application running on the customer computer, a payment interface configured to present an interface for transmitting a bank payment to the merchant, a transaction information transfer module configured to send the transaction information to a bank system, a bank payment initiator configured to send an instruction to the bank system to initiate payment using the bank system at a first time period; and send a confirmation to a payment service provider indicating payment was initiated; wherein the confirmation is sent within ten minutes of the first time period.

### CROSS REFERENCE

This application claims the benefit of priority to U.S. Provisional Application, 61/568,911, filed Dec. 9, 2011, the contents of which are incorporated by reference in their entirety.

### BACKGROUND

This disclosure relates to payment mechanisms for delivering payment to a merchant or other legal entity without needing to tender a physical credit card, check, or cash during the transaction. Rather, a process, computer, and system for paying a merchant using a computer such as a smart phone is provided.

### SUMMARY

A method of paying a merchant with a customer computer is disclosed. The method may comprise generating a barcode comprising a set of transaction information including sales and merchant information to be encoded with a merchant computer, generating an invoice comprising the barcode with the merchant computer, storing a copy of the barcode in the customer computer, entering customer information into a payment application running on the customer computer, decoding the barcode information with the payment application, and presenting an interface with three options: a) bank payment; b) credit or debit card payment; or c) mobile wallet payment.

Choosing choice a) bank payment, may cause the payment application running on the customer computer to send the transaction information to a payment service provider, receive a transaction ID linked with the transaction information at the customer computer from the payment service provider, display some transaction information on a display of the customer computer, and provide an interface with options for the bank payment: a) manual login; b) automated bank payment; or c) direct debit.

Choosing choice a) manual login, may cause the application to launch a web browser or a bank application on the customer computer to access an online or mobile bank system. Using the web browser or bank app the customer can log into a bank system account of the customer. Through the web browser or bank app, the customer can transmit the transaction information and/or transaction ID to the bank system using the payment app, send the transaction ID to the payment service provider using the bank system, send some transaction information from the payment service provider to the bank system, display information about the transaction on the display of the customer computer using the bank system, verify and/or amend the transaction, and initiate payment using the bank system. The bank system may be configured to transfer funds from the customer to the merchant or an intermediary payment service provider using the bank system, and send a confirmation notice to the merchant or the intermediary payment service provider. The payment service provider may send the confirmation notice to the merchant and/or customer, and if applicable may transfer funds minus a service fee from the payment service provider to the merchant.

Choosing choice b) automated bank payment, may cause the payment app to launch a web browser or a bank app on the customer computer to access an online or mobile bank system associated with the customer, provide the customer with an interface to initiate payment using the stored and gathered customer information and transaction information and/or transaction ID, to automatically populate fields and transfer funds from a financial account of the customer to the merchant or an intermediary payment service provider. The bank system may be configured to transfer funds from an account of the customer to the merchant or an intermediary payment service provider using the bank system, and send a confirmation notice to the merchant or intermediary payment service provider. The payment service provider may send the confirmation notice to the merchant and/or customer, and transfer funds from the payment service provider to the merchant.

Choosing choice c) direct debit, may cause the payment app to launch a web browser or an application on the customer computer providing the customer with an interface to initiate payment using the stored and gathered customer information and transaction information, send a direct debit authorization to the merchant or intermediary payment service provider allowing the debit of funds from the customer's bank account. The merchant or intermediary payment service provider notifies the debit authorization to the customer's financial institution and requests the transfer of the funds to the merchant or intermediary payment service provider; and if applicable the payment service provider may transfer the funds to the merchant.

If the customer selects choice b) credit or debit card, the application may launch a website of the merchant allowing the customer to initiate an online or mobile credit card or debit card payment by using the merchant's card payment service provider. The payment service provider may execute the online or mobile credit card or debit card payment, notify the merchant that the customer has initiated funds transfer request, and transferring funds from an account of the customer to an account of the merchant and or intermediary payment service provider. Once executed, the payment service provider may send the merchant a notice that the funds were received, and if applicable may transfer the funds minus a service fee to an account controlled by the merchant.

If the customer selects choice c) mobile wallet payment, the application may launch a web browser or mobile wallet app on the customer computer to access a wallet account. The web browser or mobile wallet app may request the customer to verify transactions details, and may request username and password or a pin to authenticate and authorize the payment before providing a transfer funds function configured to transfer funds from a wallet account of the customer to an account of the merchant or an intermediary payment service provider.

In addition to the above processes, a specially configured computer is set forth herein. The computer may comprise a processor for executing instructions stored on tangible computer readable storage media, tangible computer readable storage media for storing processor instructions. The instructions may comprise, a barcode receiver configured to receive a copy of a barcode generated by the merchant, a data input configured to receive customer information into an application running on the customer computer, a barcode decoder configured to decode the barcode information with the application, a payment interface configured to present an interface for transmitting a bank payment to the merchant, a transaction information transfer module configured to send the transaction information to a payment service provider, a transaction ID receiver configured to receive a transaction ID linked with the transaction information at the customer computer from the payment service provider, a login interface configured to provide an interface for logging into a bank system account of the customer, a transaction ID transmitter configured to transmit the transaction ID to the bank system using the application, and a bank payment initiator configured to initiate payment using the bank system.

In another configuration, a method of paying a merchant with a customer computer is disclosed. The method may comprise generating a barcode associated with transaction information to be encoded with a merchant computer; receiving a copy of the barcode at the customer computer; executing an application on the customer computer to decode the barcode information; presenting an interface for transmitting a bank payment to the merchant; logging into a bank system account of a customer; transmitting all or a part of the transaction information to the bank system using the customer computer; and initiating payment using the bank system at a first time. Either the bank system to a payment service provider may send a confirmation notice of payment to a computer of the merchant within ten minutes of the first time; and transfer funds from the payment service provider to a financial account of the merchant. The computer of the merchant may be the first computer, or it may be a second computer such as a smart phone. The merchant may receive the confirmation notice within a few seconds of transmission.

In another configuration, a computer for paying a merchant is provided. The computer may comprise a processor for executing instructions stored on tangible computer readable storage media, and tangible computer readable storage media for storing processor instructions. The instructions may comprise instructions to the processor to generate a barcode receiver configured to receive a copy of a barcode generated by a computer of the merchant; a barcode decoder configured to decode the barcode information with the application; a data input configured to receive customer information in an application running on the customer computer; a payment interface configured to present an interface for transmitting a bank payment to the merchant; a transaction information transfer module configured to send the transaction information to a bank system; and a login interface configured to provide an interface for logging into a bank system account of the customer. The computer readable media may comprise instructions for the processor to generate a bank payment initiator configured to send an instruction to the bank system to initiate payment using the bank system at a first time period; and send an instruction to the bank system to send a confirmation to a payment service provider indicating payment was initiated; wherein the confirmation is sent within ten minutes (or in some cases within a few seconds) of the first time period. Alternatively, the computer readable media may comprise instructions for the processor to generate a bank payment initiator configured to send an instruction to the bank system to initiate payment using the bank system at a first time period; and send an instruction to the bank system to send a confirmation to the merchant indicating payment was initiated; wherein the confirmation is sent within ten minutes (or in some case within a few seconds) of the first time period.

### BRIEF DESCRIPTION

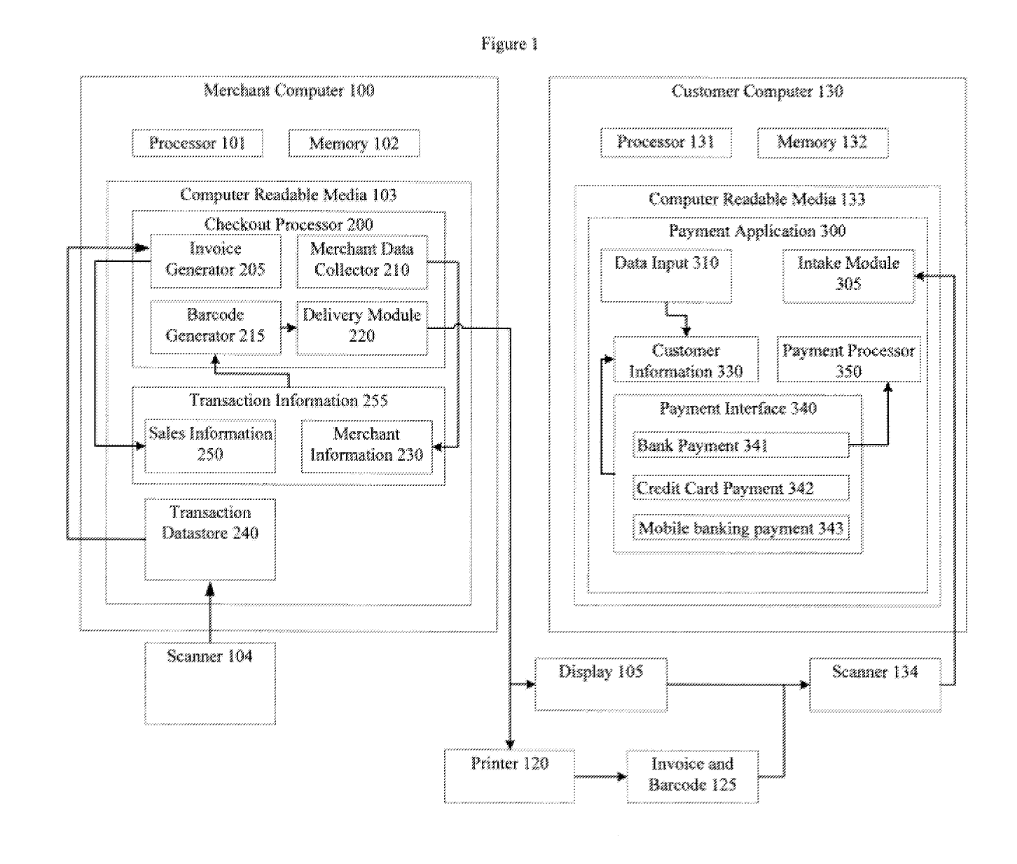

FIG. 1 is a process flow diagram of the merchant computer and the customer computer.

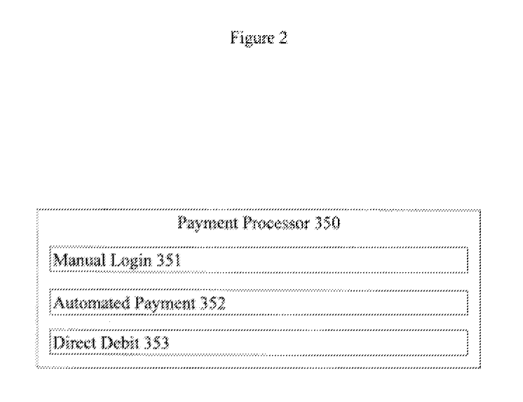

FIG. 2 is a box diagram of the processes of the payment processor.

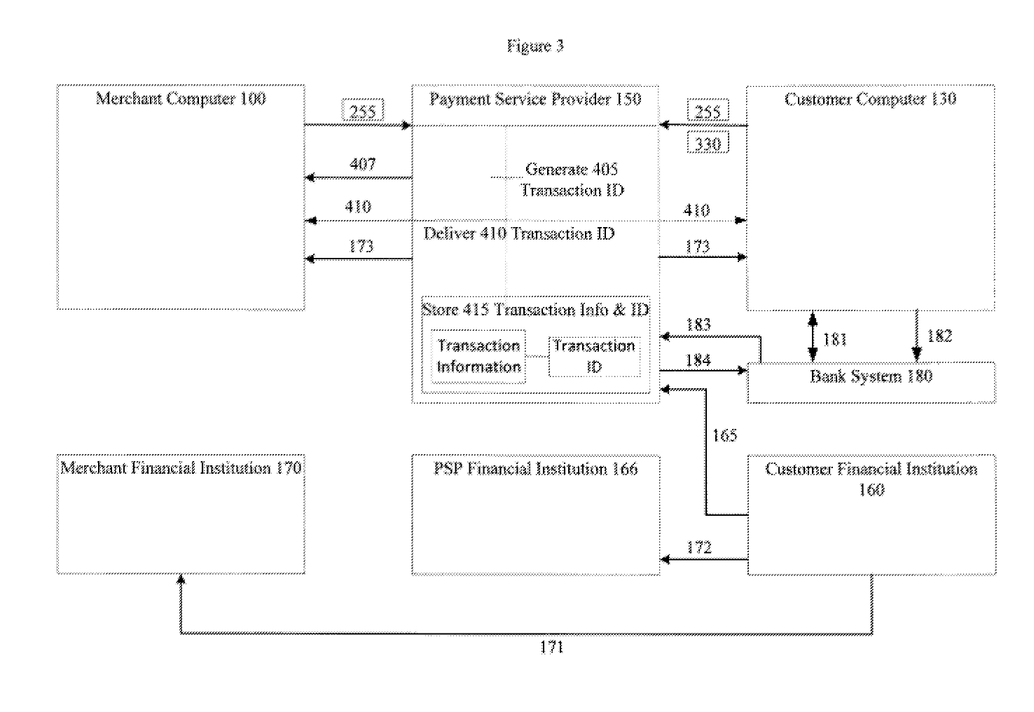

FIG. 3 is a flow diagram of the payment service provider.

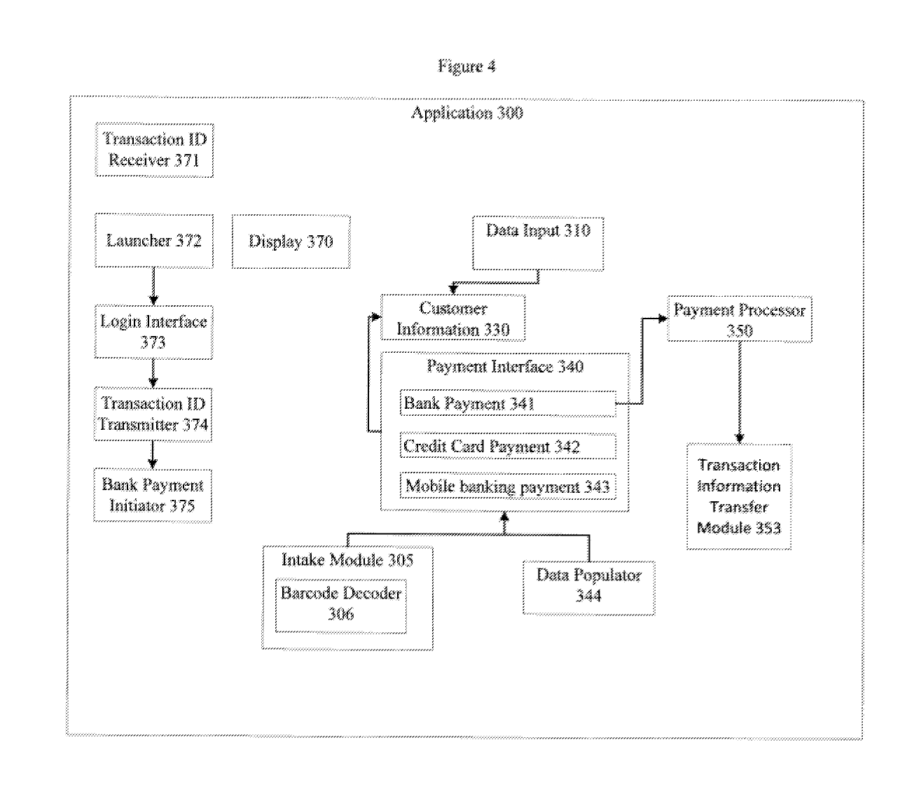

FIG. 4 is box diagram of some of the functions and modules of the application.

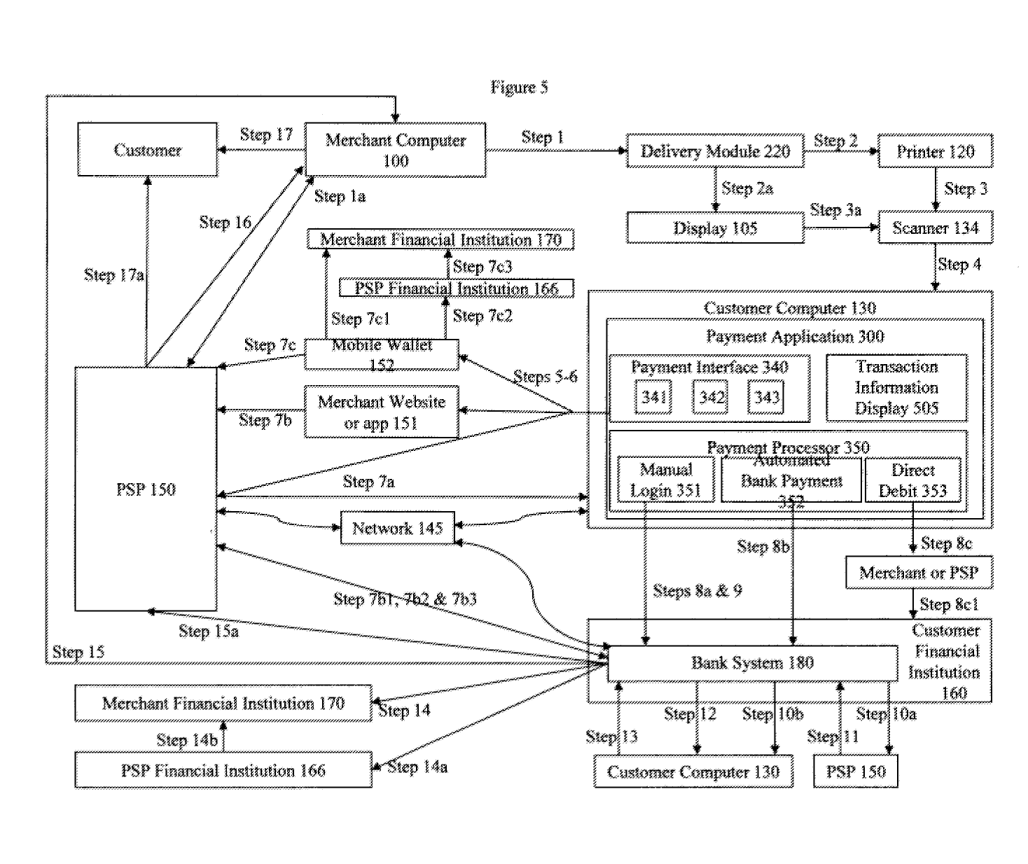

FIG. 5 is a process flow diagram of the application, merchant computer, customer computer, and the payment service provider.

### DETAILED DESCRIPTION

The following disclosed system and methods provide equipment, software, instructions, and process flows to enable a customer to pay a merchant using a customer computer. In an exemplary point of sale transaction, a customer would approach a merchant who would ring up the sale and provide a receipt for the purchase. The receipt may be electronically displayed, emailed, faxed, printed, etc. The merchant's computer may include a barcode of some sort on the receipt comprising information about the merchant and the transaction. When considering the scope of “customer” and “merchant” these terms should be afforded a meaning roughly equivalent to “payor” and “payee” respectively . . . a merchant being a legal entity intending to receive a payment for a good or service, release of obligation, satisfaction of debt, etc. while a customer is a legal entity intending to pay for the same. An exchange between two legal entities such as a tenant/landlord, lendee/lendor, patient/doctor, passenger/airline, patron/restaurant, restaurant/food service provider, resident/IRS, etc. should all be considered a customer/merchant pairs.

FIG. 1 shows a merchant computer 100 comprising computer hardware such a processor 101, memory 102, hard drive 103 (or tangible computer readable storage media). The merchant computer may be a desktop, server, laptop, smart phone or other computer device. The merchant may use more than one computer, such as a combination of a desktop and a smart phone in some configurations. The computer readable media (CRM) may comprise specially configured instructions (a checkout processor 200) comprising an invoice generator 205, merchant data collector 210, a barcode generator 215, and delivery module 220. The invoice generator 205 may request data from the computer as to the products, quantities, and price of products to be purchased (e.g. “Sales Information 250”.). Other examples of Sales Information 250 may include a sales identification number; numbers and names of items in sale, price per item, currency, sales tax, date and time of sale, etc. The merchant may input these products into a datastore 240 using a scanner 104 or other technology product recognition technology. The merchant data collector 210 is configured to store information about the merchant, i.e. the “Merchant Information 230” in the computer readable storage memory. Merchant Information 230 may include name, address, email address, website URLs, bank or other payment details of the merchant, Payment Service Provider (PSP) details, and/or merchant ID. “Transaction Information 255” may include both “Merchant Information 230” and “Sales Information 250” or an identifier associated with the Merchant Information and the Sales Information. The scanner 104 can place product information into the transaction datastore 240 which the invoice generator 205 can use to generate the sales information 250. Both the Merchant Information 230 and Sales Information 250 may be encoded by a barcode generator 215 into a barcode 125. The barcode generator may create barcodes in a number of different recognized barcodes formats such as the UPC or Matrix (2D) barcode. The checkout processor 200 can deliver the invoice and barcode to the delivery module which will format the invoice and barcode into a format suitable for final delivery to the customer computer. In some cases, the delivery module 220 may comprise an email module for delivering the invoice and barcode via email, a fax module for delivering the invoice and barcode via fax, a display module for displaying the invoice and barcode on a screen, and a printer module for formatting and delivering the invoice and barcode to a printer.

The customer computer 130 may comprise a processor 131, memory 132, and tangible computer readable storage media 133. The CRM may comprise a payment application (“the App”) 300 configured to receive the Merchant and Sales Information via a barcode receiver or intake module 305. For example, an email client may receive the email with the barcode, and a data processor may determine the Merchant Information and Sales Information from the barcode. Of course, barcodes are often used for scanners, so in some embodiments, the email module may deliver the Merchant Information and Sales Information without encoding it into a barcode. The email module may employ encryption to provide additional security to the transaction. The customer computer may also comprise an integrated camera or feature a connected scanner 134 as shown for reading a barcode displayed on a display 105 on the merchant computer 100 or printed on an invoice 125 by the printer 120. The App may interface with drivers or other software used to control an optic device such as a scanner or camera to capture an image of the barcode. The invoice intake module 305 may comprise a barcode decoder 306 (FIG. 4) configured to decode the sales and merchant information from the scanned barcode in order to provide the customer computer with the needed information to effect the payment process.

The customer computer may be a smart phone, cell phone, laptop, tablet, or any mobile or desktop computer. Once the customer computer 130 has determined the Merchant Information and Sales Information vis-á-vis the invoice intake module 205, the customer computer can initiate the payment process.

The App 300 may feature a data input 310 for the customer to enter and store (either in the computer readable media of the computer 130 or on a networked data store) various types of “Customer Information” such as a customer ID, name, delivery and billing address, bank details, account number, account access credentials, user name, password, pin, other account details, payment preferences, currency preferences, credit and/or debit card details, card numbers, expiry dates, security codes, other payment details, and information relating to the customer computer 130. The customer computer 130 may already comprise stored answers for some of these data fields, and the App 300 may communicate with the customer computer to automatically populate some of these fields by using a data populator 344 (FIG. 4) that can draw data from the CRM of the customer computer 130.

The App may comprise a payment interface 340 to offer the customer several payment options including a bank payment option 341, credit or debit card payment option 342, or a mobile wallet payment option 343. If the customer selects the bank payment option 341, (which may be stored as a default option as part of the Customer Information), the App will launch the payment processor 350 offering the customer three choices 351-353 to pay through his Bank System; manual login 351, automated bank payment 352, direct debit 353 (these choices are shown in FIG. 2). These choices are also shown in FIG. 5 as processes 8a, 8b, and 8c respectively. The bank payment option may access a PSP 150 and/or bank system 180, the credit/debit card option may access a merchant website or app 151, and the mobile wallet option may access a wallet website or app 152. A wallet account is a stored value account provided by a wallet service provider. Such accounts may have less features than bank accounts and wallet providers are more lightly regulated than banks They can be accessed via mobile phones, but often they can also be accessed and used by any internet-connected device as well as plastic cards, e.g. prepaid cards. In any of the options, the customer computer 130 and App may send via a transaction information transfer module 353 (FIG. 4) at least some Transaction and/or Customer Information to the merchant or PSP either directly, or by storing such information into a file that is then shared by uploading the file through a web browser, website, or application.

As shown in FIG. 3, a Payment Service Provider 150 or PSP is a third party computer configured to receive Transaction Information 255 either from the merchant or the customer or both, receive Customer Information 330 from the customer, generate 405 a transaction ID 410, deliver the transaction ID 410 to the merchant computer 100 and/or customer computer 130, store 415 the Transaction Information 255 together with the associated Transaction ID 410, receive 165 a confirmation from the customer's financial institution 160 that a payment to the merchant's financial institution 170 or to the PSP's financial institution 166 has been initiated. The PSP 150 may deliver 173 a notification to the Merchant Computer 100 and/or Customer Computer 130 that the payment was initiated. While the customer may interact with a website hosted by the payment service provider, in some configurations, the customer will use an application or a web browser to login into 181 a bank system 180 of the customer's financial institution 160. The bank system may receive 182 a transaction ID from the Customer Computer 130 and forward 183 this transaction ID to the PSP 150. The PSP 150 may return 184 the transaction information associated to the transaction ID to the bank system 180.

The customer, the PSP and the merchant may have an account with a financial institution 160, 166 and 170. The financial institutions (160, 166 and 170) can send and receive finances through ACH, wire, or other techniques. A “Bank System 180,” an application or web portal that a customer can access to provide information to the customer's financial institution and/or direct a specific payment to the merchant's financial institution 171 or to the PSP's financial institution 172, may be provided by the customer's financial institution (or third party hosting site) to send and receive information between the customer and the customer's financial institution.

FIG. 4 shows some additional modules/functions of the payment application 300. For example, the payment application may comprise a transaction ID receiver 371 configured to receive a transaction ID linked with the transaction information at the merchant computer from the payment service provider. A launcher 372 may launch a web browser or bank application on the customer computer. A login interface 373 may provide the customer with a screen for entering Bank System information. During login, the customer may transmit the transaction ID to the Bank System using a transaction ID transmitter 374. A bank payment initiator 375 may provide the customer a button or other interface to send an instruction to the bank system to: initiate payment using the bank system at a first time period; and send a confirmation to a payment service provider indicating payment was initiated; wherein the confirmation is sent within ten minutes of the first time period.

FIG. 5 illustrates a process flow for effecting payment to a merchant. The process flow may be implemented or executed in various sequences other than the ones provided. Although the sequences are proposed as step 1, step 2, etc., some steps may be skipped or repeated, and the arrangement of the steps may be changed depending on needs for the customer application, payment service provider, etc.

Step 1 and 1a. In step 1, a merchant computer 100 may determine transaction information to be added to an invoice from the products or services for sale. The merchant computer 100 may be configured to determine the contents of the transaction information to store into the barcode and generate the barcode with the barcode generator. In some embodiments (Step 1a), the merchant transfers the transaction information to a PSP 150, who assigns a transaction ID to the transaction information, stores both transaction ID and the corresponding transaction information in their system and returns the transaction ID to the merchant, who may encode it in addition or instead of the transaction information into the barcode. The barcode may be transferred to the Delivery Module 220.

Step 2 and 2a. In step 2, the Delivery Module 220 may be configured to collect necessary information from the merchant computer 100 to display or print the barcode. The merchant computer 100 may be configured to direct the delivery module to create an output having the Transaction Information encoded within a barcode. The output (including the invoice and barcode) may then be sent to a Printer 120 (Step 2) or a Display 105 (Step 2a).

Step 3 and 3a. The printer 120 prints an invoice comprising the barcode (Step 3) or the display 105 displays an invoice and/or barcode (Step 3a).

Step 4. A customer computer 130 can use the “App” 300 stored in memory and executed by the processor of the customer computer to scan the barcode once the image of the information is in the memory of the customer computer. The computer can then decode barcode and effect payment. If the customer computer is a smart phone, the optic device may be an integrated camera or a connected external camera. The customer computer may be connected to at least one of the participating parties in this process via a data network 145. The data network 145 may comprise standard fixed or mobile networking equipment.

Step 5. The customer may use the data input 310 to store various types of Customer Information 330 in the Computer Readable Media 133 of the customer computer.

Step 6. Using the image captured by the optic device 135 (or email received by the email client), the customer computer 130 decodes the information in the barcode. The App 300 may comprise instructions from which the processor of the customer computer can decode the barcode. Once the decoded information is obtained, the App 300 may store the Transaction Information into the computer readable media of the customer computer 130. The App may offer one or more of the payment options to the customer as shown in FIG. 1: elements 341-343. Based on the merchant information, which is part of the transaction information, there could be several providers for each payment option creating a longer list, similar to the checkout page of online merchants.

Step 7a. When selecting the bank payment option, the transaction information may be sent to the PSP 150 providing this option, who may assign a transaction ID if not already part of the transaction information and may send the transaction ID back to the customer computer 130 and App (running on the computer), which may be configured to display at least some Transaction Information 505. Depending on the stored Customer Information (in Step 5), the App may be configured to display the payment interface providing the customer with the following options for the bank payment: 8a) manual login, 8b) automated bank payment, or 8c) direct debit.

Step 7b, bypassing Steps 8-13, may be executed when option 7b) credit or debit card payment is selected by customer through the interface. The customer makes an online or mobile credit or debit card payment by using the merchant's website by either providing the card details and customer info manually or via the App 300 using stored data if available and if necessary providing the rest manually. The PSP may request authorization of the payment from the customer's financial institution (Step 7b1). The customer's financial institution may check availability of the requested amount on the customer's account, may reserve the amount for a set period and may notify the PSP if it authorizes the payment or not (Step 7b2). If authorized, the PSP may request either right away or at a later stage the customer's financial institution to transfer the authorized amount from the customer's account to the merchant or the PSP (Step 7b3).

Step 7c, bypassing Steps 8-15, may be executed when option c) mobile wallet is selected. The customer makes a mobile wallet payment by using a web browser or mobile wallet app on the customer computer to access his/her mobile wallet account by entering his/her access credentials if necessary, enter any necessary transaction information or verify and/or amend the stored Transaction Information that may have been passed on by the App; and if necessary authorize the payment to the PSP or merchant for example with a PIN, before executing it. A mobile wallet payment is confirmed by the wallet provider to the PSP or merchant. The PSP may notify (step 16) the merchant whether the payment was successful or not, and if successful, the funds are transferred from the customer's mobile wallet to the merchant's financial institution (Step 7c1) or to the PSP's financial institution (Step 7c2) through ACH or other electronic transfer mechanism. If applicable the PSP may subsequently transfer the payment to the merchant (Step 7c3).

Step 8a, returning back to the step 7a process (bank payment), in step 8a (manual login), the customer computer is configured to execute a program (such as a web browser or a bank app) for accessing the customer's Bank System 180 (such as a bank or financial institution's online or mobile banking platform). In some embodiments, this program will be launched automatically by the App 300.

Step 8b is selected when the customer selects b) automated bank payment 352 in the App (bypassing Steps 9-13). In this process, the App provides the customer with an interface to enter his or her Customer Information 330 or to verify and/or amend the stored Customer Information and then execute the payment using the Customer Bank System. The App then accesses the Bank System, using at least some of the Customer Information, navigates automatically to the Bank System's money transfer or payment screen and enters automatically the required Transaction and Customer Information from the previously entered or stored values. Depending on the bank's security processes, which vary from bank to bank, the Customer may have to authorize the payment explicitly by entering a code, e.g. a pin or one-time password into the App, and the App then executes the payment to the Merchant's or an intermediary PSP's Financial Institution by automatically selecting the bank system's money transfer or payment execution trigger.

Step 8c and 8c1. This process is started when the customer selects direct debit option 353 (bypassing Steps 9-13). In this process, the App provides the customer an interface to enter his or her Customer Information 330 or to verify and/or amend the stored Customer Information and then sends a direct debit permission to the merchant or PSP together with at least some of the Customer Information and some of the Transaction Information required to initiate a direct debit. Typically, this would contain the customer name and bank account number, the merchant or intermediary PSP name and bank account number, the order number and/or a reference number and the amount to be debited from the customer account. Based on this permission, the merchant or intermediary PSP will then request the Customer's Financial Institution to debit the amount from the customer account and transfer the funds (via ACH or otherwise) to the Merchant or intermediary PSP.

Step 9. Returning to the process where the customer selects Step 8a (manual login) and is provided with an interface to enter at least their password and/or pin manually for the purpose of signing in (authenticating) into the Bank System (Step 9). During the authentication process, the customer computer and the App may transfer some of the Transaction Information and/or Customer Information to the Bank System. In some embodiments, the customer computer device will transfer just the transaction ID or no Transaction Information and/or Customer Information at all to the Bank System. Depending on the Transaction Information passed on, the Bank System will either follow process 10a or 10b, the difference being that in step 10a, the Bank System will request any missing information to complete a payment from the PSP, whilst in step 10b it will request the Customer to enter it manually.

Step 10a, 11 and 12. If the Bank System was sent the transaction ID only, it may forward this ID to the PSP (Step 10a), which will identify the associated Transaction Information stored in their system against this transaction ID and return at least some of this corresponding Transaction Information (Step 11) to the Bank System, which will display at least some of this information on the Customer Computer (Step 12).

Step 10b. If no Transaction Information was passed on to the Bank System in Step 9, the web browser or app accessing the Bank System is configured to provide the customer with an interface to manually enter any missing Transaction Information and/or Customer Information into the Bank System to complete the payment.

Step 13. In step 13, the web browser or bank app accessing the Bank System provides the customer with an interface to see and change the Transaction and/or Customer Information, select a bank account to pay from, if more than one is available, and requests the customer to execute or cancel the payment. If an execute command is selected, the customer computer through the web browser or bank app accessing the Bank System sends a payment command to the Bank System. Some Bank Systems may challenge this command by requesting a transaction authorization code, e.g. a pin or a one-time password. If the customer selects cancel a cancellation command is sent to the Bank System and the payment is not executed. In some embodiments the customer is not allowed to change any Transaction and/or Customer Information and/or select a bank account to pay from.

Step 14, 14a and 14b. The Bank System may be configured to transfer funds from the customer's account either directly to the Merchant's account at the Merchant's Financial Institution (Step 14) or to an intermediary PSP (Step 14a), that then transfers the funds onwards either right away or later to the Merchant (Step 14b) and may deduct a commission.

Steps 15, 15a and 16. The Bank System may send a confirmation notice either directly to the merchant (Step 15) or an intermediary PSP (Step 15a) that may forward the notice right away or at a later stage to the Merchant (Step 16) in the same or modified format. For example, the merchant computer may receive a notice of confirmation within a few (a fraction of a second to ten) seconds of the time the customer computer initiates the bank payment. In another example, the merchant computer may receive the notice of confirmation within a time period of one minute to ten minutes. The confirmation notice of payment may be transmitted from either the payment service providers or the bank system. The confirmation notice may include Transaction Information and Customer Information, such as the transaction ID, customer name, transaction amount and if the payment was executed or cancelled or not completed within a defined period of time.

Steps 17 and 17a. The Customer is informed by the merchant (Step 17) and/or by the PSP (Step 17a) either verbally or through print or electronic display or email or SMS or otherwise that confirmation of payment was received or not.

### EXAMPLES

The following examples may be executed in differing sequences than the ones shown below notwithstanding the enumeration of the steps. Moreover not all of the steps should be regarded as necessarily required for performance of the processes.

### Example 1

### Bank Payment with Manual Login and Using a Transaction ID

Step 1 and 1a. Determine a set of Transaction Information (Sales and Merchant Information), send it to a PSP that assigns a unique transaction ID to it and stores both transaction ID and associated transaction information in their system and returns the transaction ID to the merchant computer, which encodes it in a barcode.

Step 2. The Delivery Module adds the barcode to the invoice and sends it to the printer.

Step 3. Print the invoice including the barcode.

Step 4. Load an application, (the “App”) on a smart phone to scan the barcode via the smart phone's camera.

Step 5. The customer configuring the App to store Customer Information, e.g. name, bank details, account access credentials, credit or debit card details, security codes, etc. The App can store this information on network or cloud storage on the smart phone itself, or on a memory card in the smart phone.

Step 6. The App decodes the barcode to retrieve the transaction ID and presents the customer with three options: a) bank payment; b) credit or debit card payment; or c) mobile wallet payment. Assuming the customer selects option a), the App will send the Transaction ID to the Payment Service Provider (PSP).

Step 7a. The PSP returns the transaction information associated with the transaction ID and to the App on the customer's smart phone, which displays it. Depending on the stored Customer Information (in Step 5) or manual choice of a specific bank and bank payment method, the App will initiate one of the following options for the bank payment: a) manual login; b) automated bank payment; or c) direct debit.

Step 8a. Assuming that the customer selects choice a), the App launches a web browser or a bank app on the customer's smart phone to access the bank's online system (the “Bank System”).

Step 9. The customer authenticates with their Bank System whereby at least their password or pin is entered manually into the Bank System. As part of the authentication process, the transaction ID is transmitted from the web browser or bank app to the Bank System of the Customer's Financial Institution.

Step 10a. The Bank System sends the transaction ID to the PSP.

Step 11. The PSP sends back the transaction information associated to this transaction ID to the Bank System.

Step 12. The Bank System displays the transaction information in the smart phone's web browser or bank app.

Step 13. The Customer verifies the displayed transaction information and executes the payment by clicking a confirm button in the web browser or bank app, which sends a message to the Bank System to trigger the payment on the Bank System

Step 14a and 14b. The Bank System transfers the funds from the customer's account to the PSP's account at the PSP's Financial Institution and the PSP will settle this payment minus their commission to the merchant's account at the Merchant's Financial Institution within an agreed settlement period.

Step 15a and 16. The Bank Systems sends a confirmation notice about the paid transaction to the PSP, who forwards the confirmation onwards to the merchant.

Step 17. Upon receipt of the confirmation, the merchant informs the customer about the successful payment and allows him or her to leave the premises with the purchased goods or services, ships the order, absolves the debt, etc.

### Example 2

### Bank Payment with Manual Login and Bypassing the Use of a PSP

Step 1. Determine a set of Transaction Information and encode it into a barcode.

Step 2. The Delivery Module adds the barcode to the invoice and sends it to the printer.

Step 3. Print the invoice including the barcode.

Step 4. A customer uses an application (the “App”) on a smart phone to scan the barcode via the smart phone's camera.

Step 5. The App can be configured by the customer to store Customer Information, e.g. name, bank details, account access credentials, credit or debit card details, security codes, etc.

Step 6. The App decodes the barcode and offers 3 options: a) bank payment; b) credit or debit card payment; c) mobile wallet payment.

Step 8a. Assuming the customer selects choice a), the App launches a web browser or a bank app on the customer's smart phone to access the customer's bank system.

Step 9. The customer authenticates with their Bank System whereby the App passes on the user name from the stored Customer Information on the smart phone and the decoded Transaction Information, but the password is entered manually by the customer.

Step 12. The Bank System displays the transaction information in the smart phone's web browser or bank app.

Step 13. The Customer verifies the displayed transaction information, selects a bank account for the payment and executes it by clicking a confirm button in the web browser or bank app, which sends a message to the Bank System to trigger the payment on the Bank System.

Step 14. The Bank System transfers the funds from the chosen account of the customer to the merchant.

Steps 15. The Bank System sends a confirmation notice about the paid transaction to the merchant.

Step 17. Upon receipt of the confirmation, the merchant informs the customer about the successful payment and allows him or her to leave the premises with the purchased goods or services, ships the order, absolves the debt, etc.

### Example 3

### Bank Payment with Automated Login

Step 1. Determine a set of Transaction Information and encode it into a barcode.

Step 2. The Delivery Module adds the barcode to the invoice and sends it to a connected tablet computer with display.

Step 3a. The tablet computer displays the invoice including the barcode.

Step 4. A customer uses an application (the “App”) on a smart phone to scan the barcode via the smart phone's camera.

Step 5. The customer configuring the App to store Customer Information, e.g. name, bank details, account access credentials, credit or debit card details, security codes, etc.

Step 6. The App decodes the barcode and offers 3 options: a) bank payment; b) credit or debit card payment; c) mobile wallet payment.

Step 8b. Assuming the customer selects a) bank payment and then b) automated bank payment, the App provides the customer with an interface to initiate payment at the push of a button by using the stored and gathered Customer and Transaction Information to access the Bank System automatically, authenticate automatically, navigate and enter the required information automatically, and then execute the payment to the merchant. If the Bank System requires a one-time password to authorize the payment, the customer enters that manually during the process.

Step 14. The Bank System transfers the funds from the customer to the merchant.

Step 15. The Bank System sends a confirmation notice about the paid transaction to the merchant.

Step 17. Upon receipt of the confirmation, the merchant informs the customer about the successful payment and allows him or her to leave the premises with the purchased goods or services, ships the order, absolves the debt, etc.

### Example 4

### Bank Payment with Direct Debit

Step 1. Determine a set of Transaction Information and encode into a barcode.

Step 2. The Delivery Module adds the barcode to the invoice and sends it to a connected tablet computer with display.

Step 3a. The tablet computer displays the invoice including the barcode.

Step 4. A customer uses an application (the “App”) on a smart phone to scan the barcode via the smart phone's camera.

Step 5. The customer configuring the App to store Customer Information, e.g. name, bank details, account access credentials, credit or debit card details, security codes, etc.

Step 6. The App decodes the barcode and offers 3 options: a) bank payment; b) credit or debit card payment; c) mobile wallet payment. For this example the choice is a) and the App will send the Transaction Information to a Payment Service Provider (PSP).

Step 7a. The PSP stores the transaction information and creates a transaction ID linked to this information. The transaction ID is sent back to the App on the customer's smart phone, which displays the relevant transaction details. Based on the stored Customer Information for this example (in Step 5), the App will initiate option c) direct debit.

Step 8c and 8c1. Bypassing Steps 9-13, the App provides the customer with an interface to initiate payment at the push of a button by using the stored and gathered Customer Information and Transaction Information to send a direct debit permission to the PSP, who, based on this permission, sends a request to the customer's financial institution (Step 8c1) to debit the customer account and transfer the funds.

Step 14a and 14b. The Bank System transfers the funds from the customer to the PSP who settles the amount after deducting their commission to the merchant one week later.

Step 15a-16. The Bank System sends a confirmation notice about the paid transaction to the PSP and the PSP forwards the confirmation right away to the merchant.

Step 17. Upon receipt of the confirmation, the merchant informs the customer about the successful payment and allows him or her to leave the premises with the purchased goods or services, ships the order, absolves the debt, etc.

### Example 5

### Credit Card/Debit Card Payment

Step 1. Determine a set of Transaction Information and encode it into a barcode.

Step 2. The Delivery Module adds the barcode to the invoice and sends it to the printer.

Step 3. Print the invoice including the barcode.

Step 4. A customer uses an application (the “App”) on a smart phone to scan the barcode via the smart phone's camera.

Step 5. The customer configuring the App to store Customer Information, e.g. name, bank details, account access credentials, credit or debit card details, security codes, etc.

Step 6. The App decodes the barcode and offers 3 options: a) bank payment; b) credit or debit card payment; c) mobile wallet payment.

Step 7b (bypassing Steps 8-13). The customer selects choice b) and makes an online or mobile credit or debit card payment by using the merchant's website including a hosted payment page of their PSP where the card details are entered. The App can be configured to provide all, much, some, or none of the required information automatically to minimize any manual input. The PSP requests (Step 7b1) and receives (Step 7b2) authorization of the payment from the Customer's Financial Institution and at a later stage requests (Step 7b3) the transfer of funds from the Customer's Financial Institution to the Merchant's account at the Merchant's Financial Institution.

Step 16. The PSP notifies the merchant computer 100 whether the payment was authorized or not. For this example we assume it was not authorized.

Step 17. Upon receipt of the denied authorization, the merchant informs the customer about the unsuccessful payment and requests him or her to pay using another card or method.

### Example 6

### Mobile Wallet Payment

Step 1. Determine a set of Transaction Information and encode it into a barcode.

Step 2. The Delivery Module adds the barcode to the invoice and sends it to the printer.

Step 3. Print the invoice including the barcode.

Step 4. A customer uses an application (the “App”) on a smart phone to scan the barcode via the smart phone's camera.

Step 5. The customer configuring the App to store Customer Information, e.g. name, bank details, account access credentials, credit or debit card details, security codes, etc.

Step 6. The App decodes the barcode and offers 3 options: a) bank payment; b) credit or debit card payment; c) mobile wallet payment. Assuming the customer selects choice c), the App will launch the mobile wallet app.

Step 7c. The customer selects choice c) to make a mobile wallet payment by using a web browser or mobile wallet app on his/her customer computer to access his/her mobile wallet account. The App passed on all the necessary customer and transaction information to authenticate his/her access and populated a payment screen with all the necessary information. The customer authorizes the payment to the PSP with a PIN, before executing it. The PSP is notified about the executed payment and the funds are transferred from the mobile wallet account to the PSP (Step 7c2) and a few days letter forwarded by the PSP to the merchant (Step 7c3).

Step 16. The merchant is notified by the PSP that the payment was successful.

Step 17. Upon receipt of the confirmation, the merchant informs the customer about the successful payment and allows him or her to leave the premises with the purchased goods or services, ships the order, absolves the debt, etc.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, i.e., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code embodied on a tangible medium that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A method of paying a merchant with a customer computer, the method comprising:
a. generating a barcode associated with transaction information to be encoded with a merchant computer;
b. receiving a copy of the barcode at the customer computer;
c. executing an application on the customer computer to decode the barcode information;
d. presenting an interface for transmitting a bank payment to the merchant;
e. logging into a bank system account of a customer;
f. transmitting all or a part of the transaction information to the bank system using the customer computer;
g. initiating payment using the bank system at a first time;
h. sending a confirmation from the bank system to a payment service provider within ten minutes of the first time;
i. sending a confirmation notice of payment from the payment service provider to a computer of the merchant within ten minutes of the first time; and
j. transferring funds to a financial account of the merchant.

2. The method of claim 1 wherein the bank system transfers the funds to the payment service provider, and the payment service provider transfers the funds to the financial account of the merchant.

3. The method of claim 1 wherein the bank system transfers the funds to the financial account of the merchant directly without using the payment service provider to transfer the funds.

4. The method of claim 1 comprising: receiving a confirmation notice of payment at the merchant computer from the bank system within a few seconds of the first time.

5. The method of claim 1 wherein the merchant computer and the computer of the merchant are the same computer.

6. The method of claim 1 wherein the merchant computer is a desktop computer and the computer of the merchant is a smart phone.

7. The method of claim 1 wherein the transaction information comprises an identifier, and the method further comprises the bank system obtaining merchant information and sales information from the payment service provider.

8. The method of claim 1 comprising:
a. sending the transaction information from the merchant to a payment service provider;
b. assigning a transaction ID to the transaction information by the payment service provider;
c. transmitting the transaction ID from the payment service provider to the merchant;
d. generating a barcode comprising the transaction ID to be encoded with a merchant computer; and
e. launching a web browser or a bank application on the customer computer to access and transmit and receive information to and from an online or mobile bank system.

9. The method of claim 1 comprising:
a. displaying information about the transaction on the display of the computer using the bank system; and
b. verifying the transaction.

10. The method of claim 1 comprising: automatically populating customer information and transaction information fields in an interface in the application.

11. The method of claim 1 comprising:
a. using an integrated camera to generate an image of the barcode; and
b. storing the image on the barcode in computer readable storage media of the computer.

12. A method of paying a merchant with a customer computer, the method comprising:
a. generating a barcode associated with transaction information to be encoded with a merchant computer;
b. receiving a copy of the barcode at the customer computer;
c. executing an application on the customer computer to decode the barcode information;
d. presenting an interface for transmitting a bank payment to the merchant;
e. logging into a bank system account of a customer;
f. transmitting all or a part of the transaction information to the bank system using the customer computer;
g. initiating payment using the bank system at a first time;
h. sending a confirmation notice of payment from the bank system to a computer of the merchant within ten minutes of the first time; and
i. transferring funds from the bank system to an account of the merchant.

13. The method of claim 12 comprising: receiving a confirmation notice of payment at the merchant computer from the bank system within a few seconds of the first time.

14. The method of claim 12 wherein the merchant computer and the computer of the merchant are the same computer.

15. The method of claim 12 wherein the merchant computer is a desktop computer and the computer of the merchant is a smart phone.

16. A computer for paying a merchant; said computer comprising: a processor for executing instructions stored on tangible computer readable storage media, tangible computer readable storage media for storing processor instructions, said instructions for the processor to generate:
a. a barcode receiver configured to receive a copy of a barcode generated by a computer of the merchant;
b. a barcode decoder configured to decode the barcode information with the application;
c. a data input configured to receive customer information in an application running on the customer computer;
d. a payment interface configured to present an interface for transmitting a bank payment to the merchant;
e. a transaction information transfer module configured to send the transaction information to a bank system;
f. a login interface configured to provide an interface for logging into a bank system account of the customer;
g. a bank payment initiator configured to send an instruction to the bank system to:
i. initiate payment using the bank system at a first time period; and
ii. send a confirmation to a payment service provider indicating payment was initiated; wherein the confirmation is sent within ten minutes of the first time period.

17. The computer of claim 16 wherein the confirmation is sent to the payment service provider from the bank system within a few seconds of the first time.

18. The computer of claim 16 comprising: a launcher for launching a web browser or a bank application on the customer computer to access an online or mobile bank system.

19. The computer of claim 16 comprising: a data populator configured to automatically populate customer information and transaction information fields in an interface in the application.

20. The computer of claim 16 comprising:
a. an integrated camera to generate an image of the barcode; and
b. an antenna for sending and receiving a wireless signal.

21. A computer for paying a merchant; said computer comprising: a processor for executing instructions stored on tangible computer readable storage media, tangible computer readable storage media for storing processor instructions, said instructions for the processor to generate:
a. a barcode receiver configured to receive a copy of a barcode generated by a merchant computer;
b. a barcode decoder configured to decode the barcode information with the application;
c. a data input configured to receive customer information in an application running on the customer computer;
d. a payment interface configured to present an interface for transmitting a bank payment to the merchant;
e. a transaction information transfer module configured to send the transaction information to a bank system;
f. a login interface configured to provide an interface for logging into a bank system account of the customer;
g. a bank payment initiator configured to send an instruction to the bank system to:
i. initiate payment using the bank system at a first time period; and
ii. send a confirmation to the merchant indicating payment was initiated;
wherein the confirmation is sent within ten minutes of the first time period.

22. The computer of claim 21 wherein the confirmation is sent to the merchant computer from the bank system within a few seconds of the first time.

23. The computer of claim 21 comprising: a launcher for launching a web browser or a bank application on the customer computer to access an online or mobile bank system.

24. The computer of claim 21 comprising: a data populator configured to automatically populate customer information and transaction information fields in an interface in the application.

25. The computer of claim 21 comprising:
a. an integrated camera to generate an image of the barcode; and
b. an antenna for sending and receiving a wireless signal.

26. The method of claim 1 wherein the bank system is an application or web portal configured to: receive information from the customer; provide information from the customer to the customer's associated financial institution; and provide information from the customer's associated financial institution to the customer.

27. The method of claim 1 wherein the bank system is configured to direct a specific payment to the merchant's financial institution.

28. The method of claim 1 wherein the bank system is configured to direct a specific payment to direct a specific payment to financial institution of the payment service provider.

29. The method of claim 1 wherein the payment service provider comprises a computer configured to: receive the transaction information from the merchant computer and the customer computer; and generate a transaction ID; deliver the transaction ID to the merchant computer.

30. The method of claim 29 wherein the payment service provider is further configured to:
associate the transaction ID with the transaction information; and store the transaction ID and transaction information in tangible computer readable media.

31. The method of claim 31 wherein the payment service provider is further configured to:
receive a confirmation from a customer financial institution that a payment to a merchant financial institution or to a financial institution of the payment service provider has been initiated; and deliver a notification to the merchant computer and customer computer that the payment was initiated.

32. The method of claim 31 wherein the payment service provider comprises is further configured to: receive a confirmation from a customer financial institution that a payment to a financial institution of the payment service provider has been initiated; and deliver a notification to the merchant computer and customer computer that the payment was initiated.

33. The method of claim 1 wherein the bank system is configured to receive a transaction ID from the customer computer and forward the transaction ID to the payment service provider.

34. The method of claim 33 wherein the payment service provider is configured to return the transaction information associated with the transaction ID to the bank system.
